(19) United States
(12) Patent Application Publication
(10) Pub. No.: US 2008/0301376 A1
(43) Pub. Date: Dec. 4, 2008

(54) Method, Apparatus, and System Supporting Improved DMA Writes

(76) Inventors: Brian D. Allison, Rochester, MN (US); David A. Shedivy, Rochester, MN (US); Kenneth M. Valk, Rochester, MN (US); Brian T. Vanderpool, Byron, MN (US)

Correspondence Address: IBM CORPORATION, 3605 HIGHWAY 52 NORTH, DEPT 917, ROCHESTER, MN, 55901-7829, US

(21) Appl. No.: 11/756,039

(22) Filed: May 31, 2007

(51) Int. Cl. G06F 12/00

(52) U.S. Cl. 711/141

(57) ABSTRACT

A memory controller receives a stream of DMA write operations and enqueues them in a queue enforcing a First-In First-Out (FIFO) order. Prior to processing a particular DMA write operation, the memory controller acquires coherency ownership of a target memory block and stores the result in a low latency array. In response to acquiring coherency ownership, this low latency array is updated to a coherency state signifying coherency ownership by the memory controller. In a pipelined array access, both the low latency array and the second array are accessed and if the lower latency second array indicates the particular coherency state with no collision indication, the memory controller signals that the particular DMA write operation can be performed, where the signaling occurs prior to results being obtained from the higher latency first array at the normal end of the array access pipeline. In response to the signaling, the memory controller performs an update to the memory subsystem indicated by the particular DMA write operation.

### BACKGROUND OF THE INVENTION

1. Technical Field

The present invention relates in general to data processing and, in particular, to cache coherent multiprocessor data processing systems employing directory-based coherency protocols.

2. Description of the Related Art

In one conventional multiprocessor computer system architecture, a Northbridge memory controller supports the connection of multiple processor buses, each of which has a one or more sockets supporting the connection of a processor. Each processor typically includes an on-die multi-level cache hierarchy providing low latency access to memory blocks that are likely to be accessed. The Northbridge memory controller also includes a memory interface supporting connection of system memory (e.g., Dynamic Random Access Memory (DRAM)).

A coherent view of the contents of system memory is maintained in the presence of potentially multiple cached copies of individual memory blocks distributed throughout the computer system through the implementation of a coherency protocol. The coherency protocol, for example, the well-known Modified, Exclusive, Shared, Invalid (MESI) protocol, entails maintaining state information associated with each cached copy of a memory block and communicating at least some memory access requests between processors to make the memory access requests visible to other processors.

As is well known in the art, the coherency protocol may be implemented either as a directory-based protocol having a generally centralized point of coherency (i.e., the memory controller) or as a snoop-based protocol having distributed points of coherency (i.e., the processors). Because a directory-based coherency protocol reduces the number of processor memory access requests must be communicated to other processors as compared with a snoop-based protocol, a directory-based coherency protocol is often selected in order to preserve bandwidth on the processor buses.

In most implementations of the directory-based coherency protocols, the coherency directory maintained by the memory controller is somewhat imprecise, meaning that the coherency state recorded at the coherency directory for a given memory block may not precisely reflect the coherency state of the corresponding cache line at a particular processor at a given point in time. Such imprecision may result, for example, from a processor “silently” deallocating a cache line without notifying the coherency directory of the memory controller. The coherency directory may also not precisely reflect the coherency state of a cache line at a processor at a given point in time due to latency between when a memory access request is received at a processor and when the resulting coherency update is recorded in the coherency directory. Of course, for correctness, the imprecise coherency state indication maintained in the coherency directory must always reflect a coherency state sufficient to trigger the communication necessary to maintain coherency, even if that communication is in fact unnecessary for some dynamic operating scenarios. For example, assuming the MESI coherency protocol, the coherency directory may indicate the E state for a cache line at a particular processor, when the cache line is actually S or I. Such imprecision may cause unnecessary communication on the processor buses, but will not lead to any coherency violation.

In multiprocessor data processing systems having a memory controller implementing a central coherence directory, the performance achieved in servicing direct memory access (DMA) operations, such as certain disk accesses and data transfers performed via a network adapter, is a key component of overall computer system performance. However, the centralization of coherency control in a central coherence directory means that DMA operations place a substantial demand on the central coherence directory, particularly when high speed networking adapters (e.g., 10 gigabit Ethernet adapters and PCI-E controllers) are implemented.

A further challenge to the memory controller is the requirement of strict DMA write ordering, which dictates that the data of a later received DMA write operation cannot become globally accessible prior to the data of an earlier received DMA write operation. To ensure observation of strict DMA write ordering, the memory controller must ensure that it has obtained coherency ownership of the target data granule of each DMA write operation before an update to the data granule is performed. The latency required to ensure coherency ownership of a data granule only increases as system complexity increases. Thus, as computer systems increase in scale to multi-node NUMA (Non-Uniform Memory Access) systems, the memory controller may have to transmit an operation to acquire coherency ownership not only on one or more local processor buses in its node, but also on interconnects to one or more remote processing nodes.

In order to reduce the latency associated with acquiring coherency ownership of the target data granules of DMA write operations in multimode NUMA systems, some prior art memory controllers for NUMA systems implement a coherency ownership prefetch operation called Acquire Serializer (ASE) for each DMA write operation. As prefetch operations, ASEs are free from the ordering constraints of DMA write operations, and thus can be utilized by the memory controller to acquire coherency ownership of multiple data granules in advance of issuance of the corresponding DMA write operations without any concern for ordering constraints. If an ASE is successful, the need to perform another remote access to obtain coherency ownership of a target data granule is eliminated, resulting in decreased DMA write latency.

Regardless of whether ASEs are employed to acquire coherency ownership of the target data granules of DMA write operations, when the DMA write operation is performed, the memory controller performs a directory lookup in the central coherence directory to verify that the memory controller has obtained (or retained) coherency ownership of the target data granule. For systems with large coherence directories, the latency of the directory lookup still limits how quickly the DMA write data becomes globally visible, and reduces the rate that DMA write operations can be performed.

### SUMMARY OF THE INVENTION

The present invention provides improved methods, apparatus, systems and program products. In one embodiment, a data processing system includes a memory subsystem and a memory controller having a central coherence directory. The memory controller receives a stream of multiple (DMA) write operations and enqueues the multiple DMA write operations in a queue from which the DMA write operations are performed in First-In First-Out (FIFO) order. Prior to processing of a particular DMA write operation enqueued within the queue according to FIFO order, the memory controller acquires, coherency ownership of a target memory block specified by the particular DMA write operation. In response to acquiring coherency ownership of the target memory block, an entry in higher latency first array and a lower latency second array are updated to a particular coherency state signifying coherency ownership of the target memory block by the memory controller. In response to the particular DMA write operation being a next DMA write operation in the stream to be performed according to the FIFO order, both the higher latency first array and the lower latency second array are accessed, and if the lower latency second array indicates the particular coherency state, the memory controller signals that the particular DMA write operation can be performed, where the signaling occurs prior to results being obtained from the higher latency first array. In response to the signaling, the memory controller performs an update to the memory subsystem indicated by the particular DMA write operation.

All objects, features, and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of an exemplary data processing system in accordance with the present invention;

FIG. 2 is a more detailed block diagram of the chipset coherency unit (CCU) of FIG. 1;

FIG. 3A illustrates an exemplary format of a pending queue (PQ) entry within the CCU of FIG. 2 in accordance with the present invention;

FIG. 3B depicts an exemplary embodiment of the coherence directory of FIG. 2 in accordance with the present invention;

FIG. 3C illustrates an exemplary embodiment of an I/O queue (IOQ) entry in accordance with the present invention;

FIG. 3D depicts an exemplary embodiment of an entry in an I/O array in the coherence directory of FIG. 3B accordance with the present invention;

FIG. 4 is a high level logical flowchart of an exemplary method by which an I/O queue (IOQ) in the memory controller of FIG. 1 processes a direct memory access (DMA) write operations in accordance with the present invention;

FIG. 5 is a high level logical flowchart of an exemplary method by which the chipset coherency unit (CCU) within the memory controller of FIG. 1 services Acquire Serializer (ASE) and DMA write requests spawned by a DMA write operation in accordance with the present invention; and

FIG. 6 is a high level logical flowchart of an exemplary method by which a central coherence directory services directory lookup requests spawned by a direct memory access (DMA) write operation in order in accordance with the present invention.

### DETAILED DESCRIPTION OF ILLUSTRATIVE EMBODIMENT

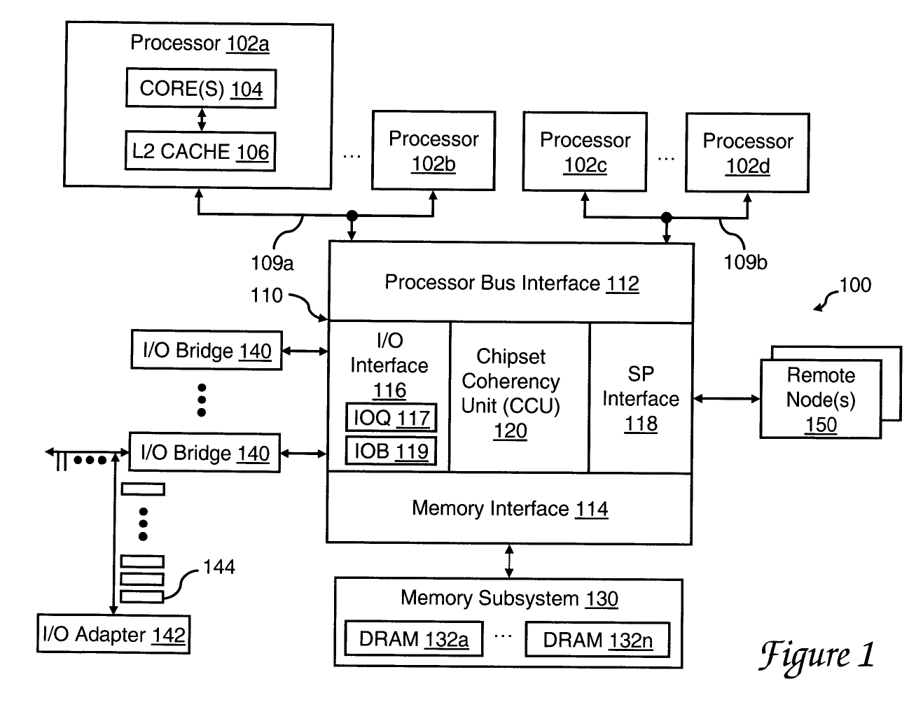

With reference now to the figures, wherein like reference numerals refer to like and corresponding parts throughout, and in particular with reference to FIG. 1, there is illustrated a high-level block diagram depicting an exemplary cache coherent multiprocessor data processing system 100 in accordance with the present invention. As shown, data processing system 100 includes multiple processors 102 (in the exemplary embodiment, at least processors 102a, 102b, 102c and 102d) for processing data and instructions. In the depicted embodiment, processors 102, which are formed of integrated circuitry, each include a level two (L2) cache 106 and one or more processing cores 104 each having an integrated level one (L1) cache (not illustrated). As is well known in the art, L2 cache 106 includes a data array (not illustrated), as well as a cache directory (not illustrated) that maintains coherency state information for each cache line or cache line sector cached within the data array. In an exemplary embodiment, the possible coherency states of cache lines held in L2 cache 106 include the Modified, Exclusive, Shared and Invalid states of the well-known MESI protocol. Of course in other embodiments, other coherency protocols may be employed.

Each processor 102 is further connected to a socket on a respective one of multiple processor buses 109 (e.g., processor bus 109a or processor bus 109b) that conveys address, data and coherency/control information. In one embodiment, communication on each processor bus 109 is governed by a conventional bus protocol that organizes the communication into distinct time-division multiplexed phases, including a request phase, a snoop phase, and a data phase.

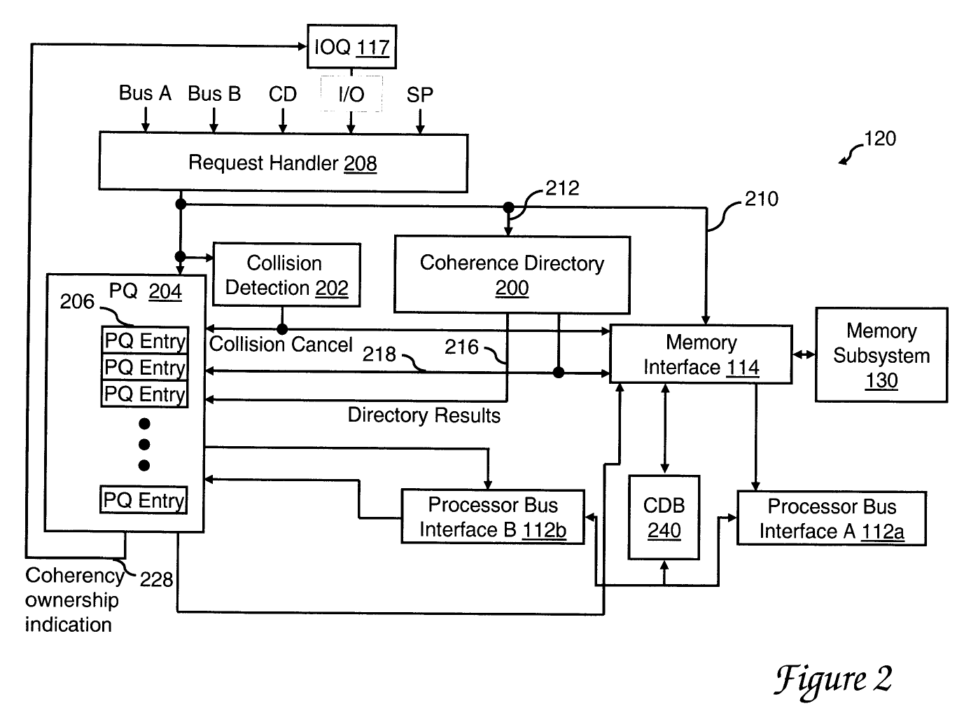

As further depicted in FIG. 1, data processing system 100 further includes a Northbridge memory controller 110. Memory controller 110, which is preferably realized as a single integrated circuit, includes a processor bus interface 112 that is connected to each processor bus 109 and that supports communication with processors 102 via processor buses 109. As indicated in FIG. 2, processor bus interface 112 preferably includes a separate instance of data buffering and bus communication logic (i.e., processor bus interface 112a, 112b as shown in FIG. 2) for each processor bus 109. Data received by each processor bus interface 112a, 112b for transmission to a processor 102 is buffered until the data is validated, and is thereafter transmitted to over the appropriate processor bus 109. The data validation may arrive before or after the data to be transmitted.

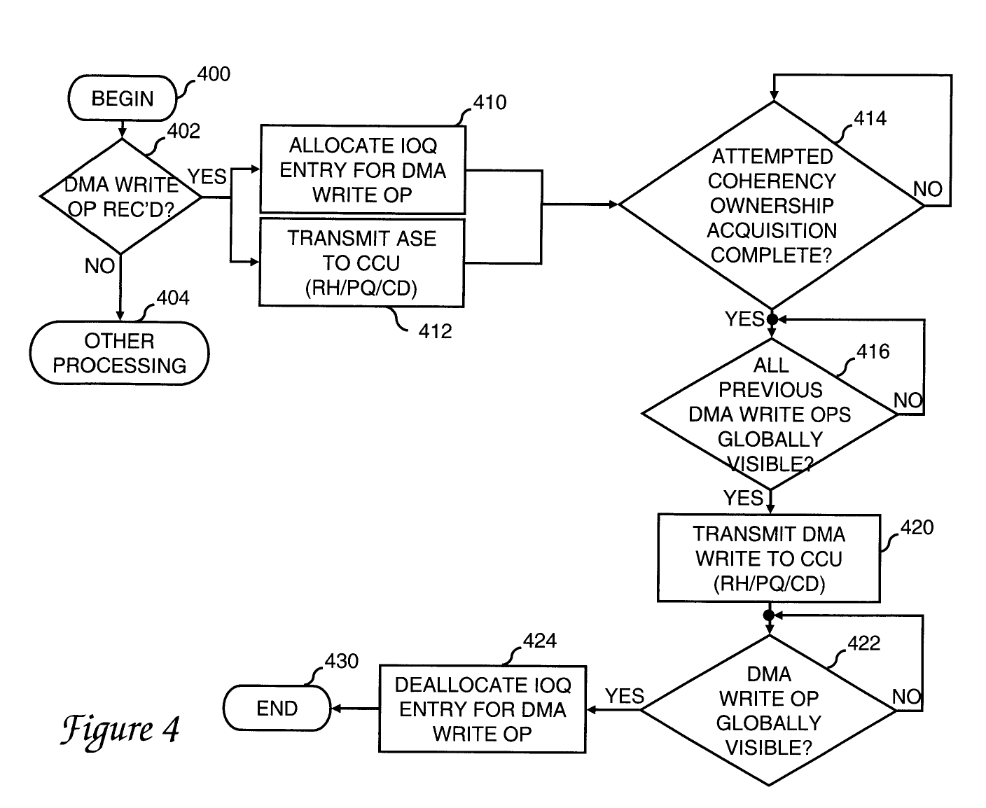

Memory controller 110 further includes a memory interface 114 that controls access to a memory subsystem 130 containing memory devices such as Dynamic Random Access Memories (DRAMs) 132a-132n and an input/output (I/O) interface 116 that manages communication with I/O devices, such as I/O bridges 140. As shown, an I/O bridge 140 is connected to an I/O bus that supports the attachment of an I/O adapter 142, which sources a stream of I/O operations such as DMA write operations 144 to I/O bridge 140. I/O bridge 140 translates each such DMA write operation 144 into one or more DMA write operations each targeting a particular memory block (e.g., a contiguous 128 bytes of real address space) in memory subsystem 130. In response to receipt of each such DMA write operation, I/O interface 116 enqueues the DMA write operation in an ordered I/O queue (IOQ) 117 that ensures strict ordering of DMA write operations is observed, as described below in greater detail with reference to FIG. 4. Data associated with DMA write operations is buffered by I/O interface 116 in an I/O buffer (IOB) 119.

Still referring to FIG. 1, memory controller 110 further includes a Scalability Port (SP) interface 118 that supports attachment of one or more optional remote nodes 150 of similar or diverse architecture to data processing system 100 in order to form a large scalable system. Memory controller 110 finally includes a chipset coherency unit (CCU) 120 that maintains memory coherency in data processing system 100 by implementing a directory-based coherency protocol, as discussed below in greater detail.

Those skilled in the art will appreciate that data processing system 100 of FIG. 1 can include many additional non-illustrated components, such as interconnect bridges, non-volatile storage, etc. Because such additional components are not necessary for an understanding of the present invention, they are not illustrated in FIG. 1 or discussed further herein.

Referring now to FIG. 2, a more detailed block diagram of an exemplary embodiment of the chipset coherency unit (CCU) 120 of memory controller 110 of FIG. 1 is depicted with reference to other components of data processing system 100. As shown, CCU 120 includes a coherence directory 200 that records a respective coherency state for each processor 102 in association with the memory address of each memory block cached by any of processors 102 (i.e., coherence directory 200 is inclusive of the contents of L2 caches 106).

CCU 120 further includes collision detection logic 202 that detects and signals collisions between memory access requests and a request handler 208 that serves as a point of serialization for memory access and coherency update requests received by CCU 120 from processor buses 109a, 109b, coherence directory 200, I/O interface 116, and SP interface 118. CCU 120 also includes a central data buffer (CDB) 240 that buffers memory blocks associated with pending memory access requests and a pending queue (PQ) 204 that buffers memory access and coherency update requests until serviced. PQ 204 includes a plurality of PQ entries 206 for buffering the requests, as well as logic for appropriately processing the memory access and coherency update requests to service the requests and maintain memory coherency.

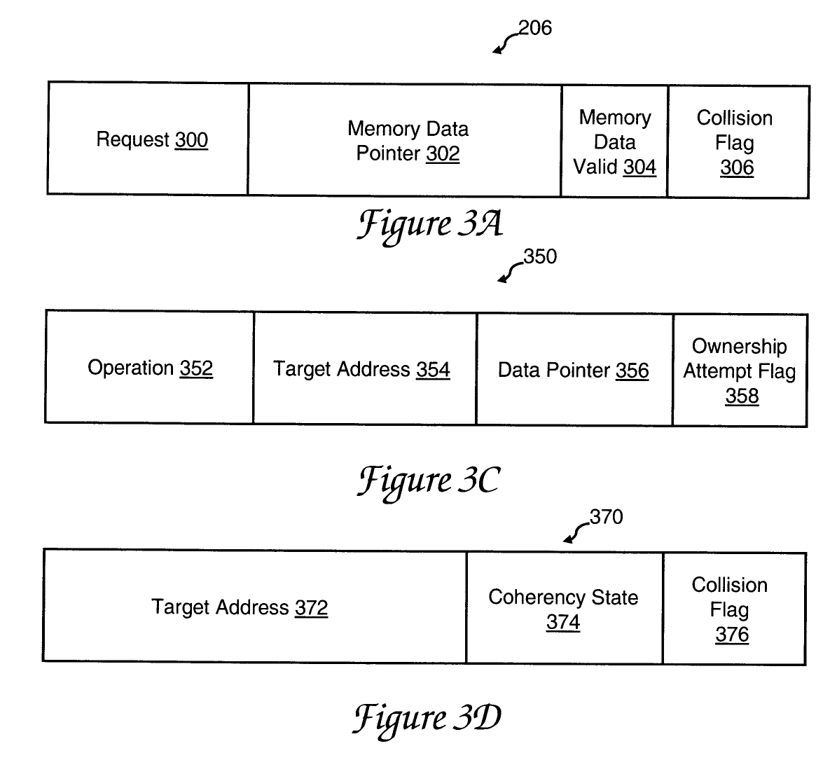

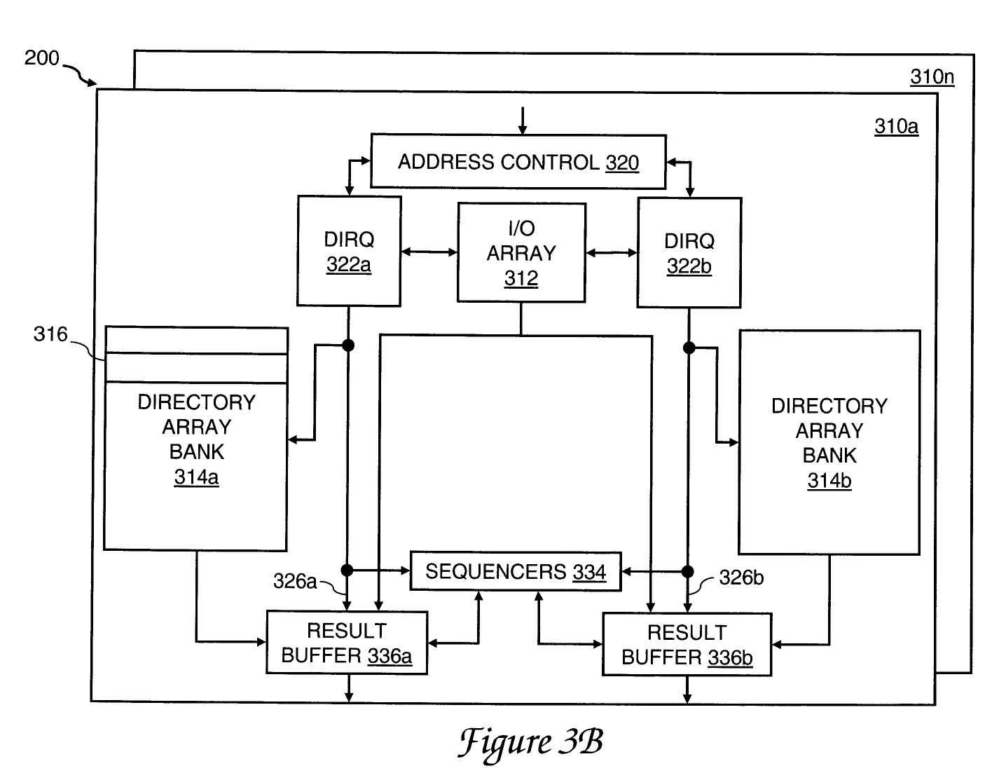

With reference now to FIG. 3A, there is illustrated an exemplary embodiment of a pending queue (PQ) entry 206 within CCU 120 of FIG. 2 in accordance with the present invention. In the depicted embodiment, PQ entry 206 includes a request field 300 for buffering the pending memory access or coherency update request to which PQ entry 206 is allocated, a memory data pointer field 302 for identifying a location within a central data buffer (CDB) 240 in which a memory block read from or to be written to memory subsystem 130 by the memory access request is buffered, and a memory data valid field 304 indicating whether or not the content of indicated location within CDB 240 is valid. In at least one embodiment of the present invention, PQ entry 206 further includes a collision flag 306 that provides an indication of whether or not an address collision has occurred for the memory access request to which PQ entry 206 is allocated.

Referring now to FIG. 3B, there is depicted a more detailed view of an embodiment of coherence directory 200 in accordance with the present invention. In the depicted embodiment, coherence directory 200 includes multiple identical directory “slices” 310a-310n, which are each responsible for tracking coherency states for a respective set of addresses within memory subsystem 130 and the I/O address space employed by the I/O devices.

Each directory slice 310 includes a memory directory array for tracking the coherency and ownership of a respective set of real memory addresses within memory subsystem 130. In the depicted embodiment, the memory directory array is implemented with a pair of directory array banks 314a-314b (but in other embodiments could include additional banks). Each directory array bank 314 includes a plurality of directory entries 316 (only one of which is shown) for storing coherency information for a respective subset of the real memory addresses assigned to its slice 310. In an exemplary embodiment, the possible coherency states that may be recorded in entries 316 include the Exclusive, Shared and Invalid states of the MESI protocol.

In one embodiment, target real memory addresses corresponding to odd multiples of the memory block size (e.g., 128) are queued in directory array bank 314a, and target real memory addresses corresponding to even multiples of the memory block size are queued in directory array bank 314b. Even though in practical implementations the memory directory array has fewer entries 316 that the number of memory blocks in memory subsystem 130, the memory directory array can be very large. Consequently, directory array banks 314 typically exhibit multi-cycle access latency and are implemented in typical commercial applications with a cost-effective (albeit slower) memory technology, such as embedded dynamic access random access memory (eDRAM).

Each directory slice 310 also includes address control logic 320, which initially receives requests of processors 102 and I/O devices 140 and determines by reference to the request addresses specified by the requests whether the requests are to be handled by that directory slice 310. If a request is a memory access request, address control logic 320 also determines which of directory array banks 314 holds the relevant coherency information and dispatches the request to the appropriate one of directory queues (DIRQs) 322a, 322b for processing.

Directory queues 322a, 322b are each coupled to I/O array 312, which tracks coherency ownership of a set of recently referenced I/O addresses. To promote rapid access times, I/O array 312 is preferably a small (e.g., 16-32 entry) storage area implemented with latches or other high-speed storage circuitry.

As depicted in FIG. 3D, an exemplary entry 370 in I/O array 312 includes a target address field 372, a coherency state field 374, and a collision flag 376. Coherency ownership of a memory block by memory controller 110 is signified in I/O array 312 by storing the real memory address of the memory block in the target address field 372 of an entry 370 in association with an F coherency state in coherency state field 374. The F coherency state signifies coherency ownership of the associated memory block by memory controller 110 with possibly invalid data residing in memory subsystem 130. In a multi-node NUMA system, the F coherency state indicates that only coherency ownership of a line was transferred to the requesting node, with no backing data to store into a local cache. Collision flag 376 indicates whether the F coherency state indicated by coherency state field 374 is “clean” or has been invalidated by a colliding access to the target memory address detected by coherence directory 200.

Directory queues 322a, 322b are each further coupled to a respective directory pipeline 326a or 326b. Each directory pipeline 326 initiates access, as needed, to its directory array bank 314 and a pool of sequencers 334 responsible for implementing a selected replacement policy for the entries 316 in directory array banks 314. Directory pipelines 326 each terminate in a respective one of result buffers 336a, 336b, which return requested coherency information retrieved from I/O array 312 or directory array banks 314 to PQ 204 (as shown at reference numeral 216 in FIG. 2).

With reference now to FIG. 4, there is illustrated a high level logical flowchart of an exemplary method by which an I/O queue (IOQ) in the memory controller of FIG. 1 processes a direct memory access (DMA) write operation in a stream of DMA write operations in accordance with the present invention. As illustrated, the process begins at block 400 in response to receipt of an I/O operation by IOQ 117 and then proceeds to block 402, which illustrates IOQ 117 determining the type of the I/O operation. In response to a determination at block 402 that the I/O operation is a DMA write operation received from an I/O bridge 140, the process proceeds to blocks 410 and 412, which are described below. If, however, a determination is made at block 402 that the I/O operation is other than a DMA write operation, IOQ 117 performs other processing, as shown at block 404.

As shown at block 410, in response to a determination that the I/O operation is a DMA write operation, IOQ 117 allocates one of its entries to the DMA write operation. As illustrated in FIG. 3C, in an exemplary embodiment, an entry 350 in IOQ 117 includes an operation field 352 that indicates the operation type, a target address field 354 that indicates the real address of the target memory block in memory subsystem 130 that is to be updated by the DMA write operation, a data pointer 356 identifying a location in I/O buffer (IOB) 119 that contains the data to be written into the target memory block, and an ownership attempt flag 358 indicating whether or not memory controller 110 has completed a coherency ownership operation of the target memory block. Importantly, IOQ 117 causes the memory updates indicated by the DMA write operations enqueued therein to be performed strictly in order, meaning that the memory update of a later received DMA write operation is never permitted to achieve global visibility prior to an earlier received DMA write operation.

The strict ordering applied to the memory updates specified by the DMA write operation does not, however, imply any ordering to other aspects of the DMA write operation, such as the acquisition of coherency ownership. Accordingly, at block 412, IOQ 117 transmits an Acquire Serializer (ASE) request to PQ 204 in order to attempt to acquire coherency ownership of the target memory block via a dataless prefetch. It will be appreciated that because the ASE request is a prefetch request rather than a demand operation, the attempt to acquire ownership by the ASE request transmitted to CCU 120 may fail under certain circumstances. In such cases, the subsequent DMA write request itself acquires coherency ownership of the target memory block when the request is presented.

Following blocks 410 and 412, the process passes to blocks 414 and 416, which respectively illustrate IOQ 117 determining whether an attempt to acquire coherency ownership of the target memory block specified by the DMA write operation has been completed and determining whether all DMA write operations preceding the current DMA write operation have achieved global visibility. In the embodiment depicted in FIG. 3C, IOQ 117 makes the determination shown at block 414 by determining whether ownership attempt flag 358 has been set by PQ 204 to signify that an attempt to obtain coherency ownership of the target memory block has been completed.

When both of the conditions represented by decision blocks 414 and 416 have been met, the process proceeds to block 420. Block 420 illustrates IOQ 117 issuing a DMA write request to PQ 204 to cause the memory update indicated by the DMA write operation to be performed. IOQ 117 thereafter retains the entry allocated to the DMA write operation within IOQ 117 until an indication that the update to memory has become globally visible has been received from PQ 204 (block 422). In response to receipt of an indication from PQ 204 that the memory update has become globally visible, IOQ 117 deallocates the entry allocated to the DMA write request (block 424). The process depicted in FIG. 4 thereafter terminates at block 430.

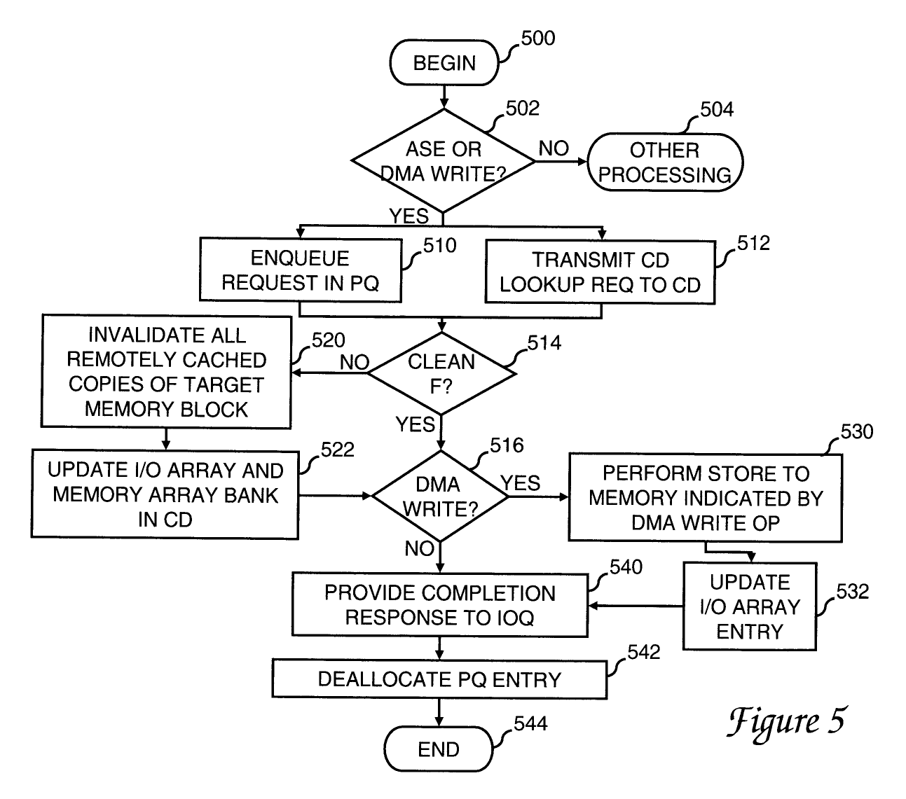

Referring now to FIG. 5, there is depicted a high level logical flowchart of an exemplary method by which CCU 120 within memory controller 110 of FIG. 1 services Acquire Serializer (ASE) and DMA write requests spawned by a DMA write operation in accordance with the present invention. The process begins at block 500 in response to receipt of a request by request handler 208. As indicated at block 502, if the request is an ASE or DMA write request received from IOQ 117, the process proceeds to blocks 510 and 512 and following blocks, which are described below. If, however, the request is other than an ASE or DMA write request, other processing is performed, as shown at block 504.

In response to receipt of the ASE or DMA write request, request handler 208 enqueues the request in an entry 206 of PQ 204 and transmits a directory lookup request to coherence directory 200 that includes at least the target address of the DMA write operation. PQ 204 then awaits receipt of the results of the directory lookup request, as shown at reference numeral 216 of FIG. 2. In response to receipt of the results of the directory lookup request, PQ 204 then determines at block 514 whether the request was “clean”, meaning that collision detection logic 202 did not set collision flag 306 to indicate that an address collision occurred for the target address in the time interval between the ASE and the DMA write requests, and whether the coherency state returned by coherence directory 200 is F, meaning that memory controller 110 has acquired coherency ownership of the target memory block. If PQ 204 makes a negative determination at block 514, the process passes to block 520, which is described below. If, however, PQ 204 makes a positive determination at block 514, the process proceeds to block 516 and following blocks.

Referring now to block 520, in response to a negative determination at block 514, PQ 204 transmits one or more invalidation requests to local or remote processors 102 identified by the directory results provided by coherence directory 200. Once all such invalidation requests are guaranteed to complete in accordance with the bus communication protocol implemented by data processing system 100, PQ 204 updates an entry 370 in I/O array 312 to associate the F coherency state with the target address of the DMA write operation (block 522). In addition, the relevant entry 318 in one of directory array banks 314a, 314b is updated to the I coherency state, The process then proceeds to block 516.

At block 516, PQ 204 determines whether the request enqueued within its entry 206 is a DMA write or ASE request. If the request is an ASE request, which as noted above is a dataless coherency prefetch, no update to memory subsystem 130 is made, and the process proceeds directly to block 540. If, however, the request is a DMA write request, PQ 204 performs the requested update to the target memory block in memory subsystem 130 via memory interface 114, as shown at block 530 of FIG. 5 and at reference numeral 218 of FIG. 2. In the depicted embodiment, the DMA store data is transferred from IOB 109 to CDB 240, and the buffer number in CDB 240 is passed to CCU 120 along with the DMA write request. To commit the DMA data to memory subsystem 130, PQ 204 sends a write request to memory interface 114, along with the buffer number, and memory interface 114 performs the memory update utilizing a write queue that maintains ordering. Thus, any subsequent read of the target address of the DMA write request is guaranteed to receive the new data. As shown at block 532, PQ 204 also signals I/O array 312 to clear the F coherency state for the target memory block from the relevant entry 370 in I/O array 312.

Following block 532 or a negative determination at block 516, the process proceeds to block 540, which depicts PQ 204 providing an completion indication to IOQ 117. As described above, an ownership indication provided in response to an ASE request causes IOQ 117 to make an affirmative determination at block 414 of FIG. 4, and a completion indication provided in response to a DMA request causes IOQ 117 to make an affirmative determination at block 422 of FIG. 4. At block 542, PQ 204 deallocates the entry 206 allocated to the ASE or DMA write request. Thereafter, the process terminates at block 544.

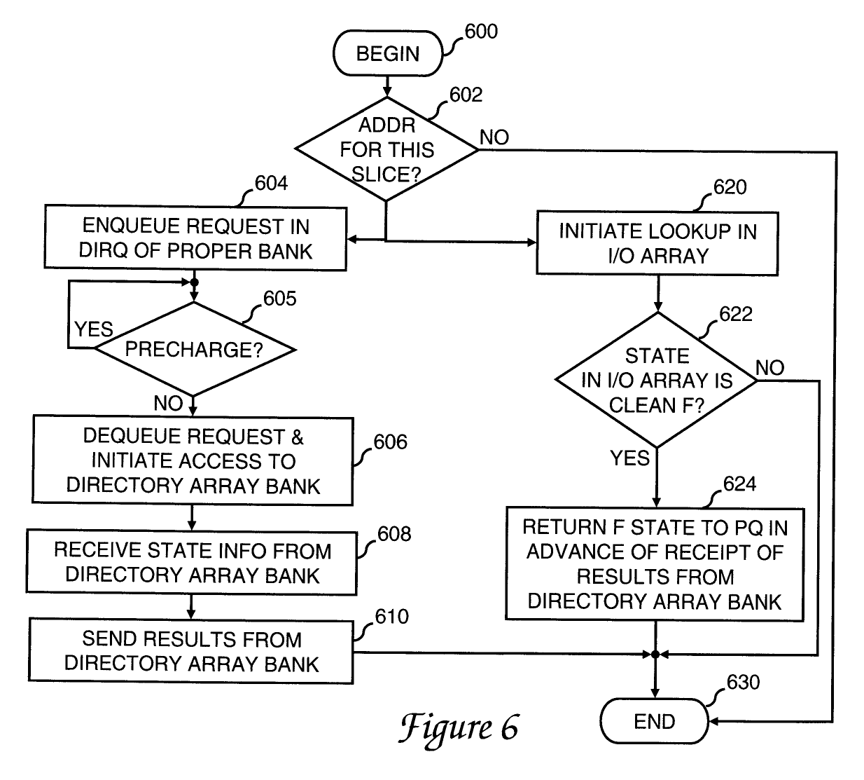

With reference now to FIG. 6, there is illustrated a high level logical flowchart of an exemplary method by which central coherence directory 200 services directory lookup requests spawned by a direct memory access (DMA) write operation in order in accordance with the present invention. The process begins at block 600 in response to receipt by coherence directory 200 of a directory lookup request, as also shown at block 512 of FIG. 5. The directory lookup request contains at least the target address of a DMA write request or ASE request. In response to receipt of the directory lookup request, address control logic 320 of each directory slice 310 makes a determination, as shown at block 602, of whether the target real memory address is assigned to that directory slice 310. Each instance of address control logic 320 may make the determination depicted at block 602, for example, by hashing the specified target real memory address or by comparing the target real memory address to the contents of one or more address range registers. In response to address control logic 320 determining at block 602 that the target real memory address is not assigned to its directory slice 310, address control logic 320 discards the directory lookup request, and the process terminates at block 630. If, however, an instance of address control logic 320 determines at block 602 that the directory lookup request is for a real memory address assigned to its directory slice 310, the process proceeds in parallel to blocks 604 and 620.

Block 604 and following blocks 605-610 represent a conventional directory access, which includes enqueuing the directory lookup request at block 604 in the directory queue (DIRQ) 322 of the directory array bank 314 to which the target real memory address maps. As noted above, in one embodiment, target real memory addresses corresponding to odd multiples of the memory block size (e.g., 128) are assigned to directory array bank 314a, and target real memory addresses corresponding to even multiples of the memory block size are assigned to directory array bank 314b. As indicated at block 605, processing of the enqueued request is delayed, if necessary, until the associated directory array bank 314 is precharged. Subsequently, during processing in the associated directory pipeline 326, access to the associated directory array bank 314 is initiated (block 606). Because of the size of directory array banks 314 and the dynamic memory technology with which it is implemented, the access typically takes several (e.g., 4-5) cycles. The results of the lookup in the directory access bank 314 are then received by result buffer 336 (block 608). The directory lookup results indicate a coherency state for the target memory block, as well as the identity of the processor(s) 102, if any, that cache a copy of the target memory block. Result buffer 336 then transmits the results of the directory lookup to PQ 204, as shown at block 610 and at reference numeral 216 of FIG. 2. The branch of the process including blocks 604-610 then terminates at block 630.

Referring now to block 620, the directory queue 322 to which the directory lookup request initiates a lookup of the target address in I/O array 312, preferably in parallel with the enqueuing operation illustrated at block 604. Because the I/O array 312 is small and implemented utilizing latches (or other high speed storage circuitry), results of the lookup of I/O array 312 can often be obtained in the same clock cycle that the directory lookup request is enqueued in directory queue 322. As shown at blocks 622-624, if the results of the lookup in I/O array 312 indicate that target real memory address hit in an entry 370 of I/O array 312 in the F coherency state without its collision flag 376 set, coherence directory 200 provides a clean F response to PQ 204 in advance of receipt of the results of the directory lookup in directory array bank 314. Thereafter, the branch of the process including blocks 620-624 terminates at block 630. If, on the other hand, the target address does not hit in an entry 370 of I/O array 312 having the F coherency state and no collision flag 376 set, the process bypasses block 624 and terminates at block 630.

By transmitting an early indication of the clean F coherency state from coherence directory 200 to PQ 204 as shown at block 624, PQ 204 is able to process ASE and DMA write requests at lower latency, improving overall DMA write throughput. The decrease in latency achieved for a particular DMA write operation varies depending between dynamic operating scenarios, but can be as much as the duration of a precharge cycle for a memory array bank 314 plus the difference in access times between memory array bank 314 and I/O array 312.

As has been described, the present invention provides improved methods, apparatus and systems for data processing in a data processing system. According to one aspect of the present invention, a memory controller acquires, without regard to any ordering requirements, coherency ownership of the target memory block of a DMA write operation and updates a higher latency first array and a lower latency second array accordingly. Both the first and second arrays are then accessed, and if the lower latency second array indicates the particular coherency state, the memory controller, prior to results being obtained from the higher latency first array, signals that the particular DMA write operation can be performed. In response to the signaling, the memory controller performs an update to the memory subsystem indicated by the DMA write operation.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to a data processing system hardware components that perform the functions of the present invention, it should be understood that present invention may alternatively be implemented partially or fully in software or firmware program code that is processed by data processing system hardware to perform the described functions. Program code defining the functions of the present invention can be delivered to a data processing system via a variety of computer-readable media, which include, without limitation, non-rewritable storage media (e.g., CD-ROM or non-volatile memory), rewritable storage media (e.g., a floppy diskette or hard disk drive), and communication media, such as digital and analog networks. It should be understood, therefore, that such computer-readable media, when carrying or encoding computer readable instructions that direct the functions of the present invention, represent alternative embodiments of the present invention.

What is claimed is:

1. A method of data processing in a data processing system including a memory subsystem and a memory controller having a central coherence directory, said method comprising:
the memory controller receiving a stream of multiple direct memory access (DMA) write operations and ordering the multiple DMA write operations such that the DMA write operations are performed in First-In First-Out (FIFO) order;
prior to processing of a particular DMA write operation according to the FIFO order, the memory controller acquiring coherency ownership of a target memory block specified by the particular DMA write operation;
in response to acquiring coherency ownership of the target memory block, updating an entry in a lower latency second array to a particular coherency state signifying coherency ownership of the target memory block by the memory controller;
in response to the particular DMA write operation being a next DMA write operation in the stream to be performed according to the FIFO order:
accessing both a higher latency first array and the lower latency second array;
if the lower latency second array indicates the particular coherency state, signaling, prior to results being obtained from the higher latency first array, that the particular DMA write operation can be performed; and
in response to the signaling, the memory controller performing an update to the memory subsystem indicated by the particular DMA write operation.

2. The method of claim 1, wherein:
the data processing system includes a plurality of processors each having a respective one of a plurality of cache memories; and
acquiring coherency ownership includes the memory controller issuing one or more operations to invalidate any cached copy of the target memory block held in the plurality of caches without flushing the contents of the target memory block to the memory subsystem.

3. The method of claim 1, wherein acquiring coherency ownership comprises acquiring coherency ownership without regard to the FIFO order.

4. The method of claim 1, wherein signaling that the particular DMA write operation can be performed comprises transmitting an indication of said particular coherency state.

5. The method of claim 1, and further comprising:
prior to said acquiring, performing a directory lookup; and
performing the acquiring only if the directory lookup indicates the memory controller does not currently have coherency ownership of the target memory block.

6. The method of claim 1, wherein accessing said lower latency second array comprises accessing a second array formed of latches.

7. The method of claim 1, wherein:
the method further comprises providing an flag in the lower latency array indicating whether a reference to the target memory block has been detected after acquisition of coherency ownership for the target memory block; and
said signaling is performed only if the flag indicates no reference to the target memory block has been detected after acquisition of coherency ownership of the target memory block.

8. A memory controller for a data processing system including a memory subsystem, said memory controller comprising:
a memory interface coupled to the memory subsystem;
an Input/Output (I/O) interface including an I/O queue from which DMA write operations are performed in First-In First-Out (FIFO) order, wherein the I/O interface receives a stream of multiple direct memory access (DMA) write operations and enqueues the multiple DMA write operations in the I/O queue; and
a coherency unit including a coherence directory, wherein the coherency unit, prior to processing of a particular DMA write operation enqueued within the queue according to the FIFO order, acquires coherency ownership of a target memory block specified by the particular DMA write operation and, in response to acquiring coherency ownership of the target memory block, updates an entry in a lower latency second array to a particular coherency state signifying coherency ownership of the target memory block by the memory controller, and wherein responsive to the particular DMA write operation being a next DMA write operation in the stream to be performed according to the FIFO order, the coherency unit accesses both a higher latency first array and the lower latency second array, and if the lower latency second array indicates the particular coherency state, signals, prior to results being obtained from the higher latency first array, that the particular DMA write operation can be performed;
wherein the memory controller, in response to the signaling, performs an update to the memory subsystem indicated by the particular DMA write operation.

9. The memory controller of claim 8, wherein:
the data processing system includes a plurality of processors each having a respective one of a plurality of cache memories; and
the coherency unit acquires coherency ownership by issuing one or more operations to invalidate any cached copy of the target memory block held in the plurality of caches without flushing the contents of the target memory block to the memory subsystem.

10. The memory controller of claim 8, wherein the coherency unit acquires coherency ownership of the target memory block without regard to the FIFO order.

11. The memory controller of claim 8, wherein the coherency unit signals that the particular DMA write operation can be performed by transmitting an indication of said particular coherency state.

12. The memory controller of claim 8, wherein the coherency unit performs a directory lookup in the coherence directory and thereafter acquires coherency ownership of the target memory block only if the directory lookup indicates the memory controller does not currently have coherency ownership of the target memory block.

13. The memory controller of claim 8, wherein said lower latency second array is formed of latches.

14. The memory controller of claim 8, wherein:
the lower latency array includes a flag indicating whether a reference to has been made to the target memory block after acquisition of coherency ownership for the target memory block; and
said coherency unit signals that the particular DMA write operation can be performed prior to results being obtained from the higher latency first array only if the flag indicates no reference to the target memory block has been detected after acquisition of coherency ownership of the target memory block.

15. A data processing system, comprising:
multiple processors each having a respective associated cache memory;
a memory subsystem; and
a memory controller coupled to the multiple processors and the memory subsystem, said memory controller including:
a memory interface coupled to the memory subsystem;
an Input/Output (I/O) interface including an I/O queue from which DMA write operations are performed in First-In First-Out (FIFO) order, wherein the I/O interface receives a stream of multiple direct memory access (DMA) write operations and enqueues the multiple DMA write operations in the I/O queue; and
a coherency unit including a coherence directory, wherein the coherency unit, prior to processing of a particular DMA write operation enqueued within the queue according to the FIFO order, acquires coherency ownership of a target memory block specified by the particular DMA write operation and, in response to acquiring coherency ownership of the target memory block, updates an entry in higher latency first array and a lower latency second array to a particular coherency state signifying coherency ownership of the target memory block by the memory controller, and wherein responsive to the particular DMA write operation being a next DMA write operation in the stream to be performed according to the FIFO order, the coherency unit accesses both the higher latency first array and the lower latency second array, and if the lower latency second array indicates the particular coherency state, signals, prior to results being obtained from the higher latency first array, that the particular DMA write operation can be performed;
wherein the memory controller, in response to the signaling, performs an update to the memory subsystem indicated by the particular DMA write operation.

16. The data processing system of claim 15, wherein:
the coherency unit acquires coherency ownership by issuing one or more operations to invalidate any cached copy of the target memory block held in the plurality of caches without flushing the contents of the target memory block to the memory subsystem.

17. The data processing system of claim 15, wherein the coherency unit acquires coherency ownership of the target memory block without regard to the FIFO order.

18. The data processing system of claim 15, wherein the coherency unit signals that the particular DMA write operation can be performed by transmitting an indication of said particular coherency state.

19. The data processing system of claim 15, wherein the coherency unit performs a directory lookup in the coherence directory and thereafter acquires coherency ownership of the target memory block only if the directory lookup indicates the memory controller does not currently have coherency ownership of the target memory block.

20. The data processing system of claim 15, wherein said lower latency second array is formed of latches.

21. The data processing system of claim 15, wherein:
the lower latency array includes a flag indicating whether a reference to has been made to the target memory block after acquisition of coherency ownership for the target memory block; and
said coherency unit signals that the particular DMA write operation can be performed prior to results being obtained from the higher latency first array only if the flag indicates no reference to the target memory block has been detected after acquisition of coherency ownership of the target memory block.
